(19) United States
(12) Patent Application Publication
(10) Pub. No.: US 2004/0267391 A1
(43) Pub. Date: Dec. 30, 2004

(54) Method for determining the effects of manufacturing decisions

(76) Inventors: Martin Bohn, Grafenau (DE); Thomas Herkenrath, Wernau (DE); Andreas Pietsch, Herrenberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/481,243

(22) PCT Filed: May 31, 2002
(86) PCT No.: PCT/EP02/05992

(30) Foreign Application Priority Data
Jun. 20, 2001 (DE) 101 29 676.2

(51) Int. Cl. G06F 19/00

(52) U.S. Cl. 700/97; 702/1

(57) ABSTRACT

The invention relates to a method which is used in the computer-supported design of a physical object, preferably for tolerance planning or for defining a clamping and securing concept, and which automatically determines effects of definitions for a first reference element on a first partial object of a physical object. In the inventive method, target objects for a first reference element on a first partial object of the physical object are automatically searched for. In this context, a target object is a partial object which occurs after the first partial object in the assembly sequence and holds and/or secures the first partial object in the first reference element. Refinements of the invention provide for various reference elements to be compared, or for further reference elements to be generated automatically.

### BACKGROUND AND SUMMARY OF THE INVENTION

This application claims the priority of German patent document 101 29 676.2, filed 20 Jun. 2001 (PCT International Application No.: PCT/EP02/05992, filed 31 May 2002), the disclosure of which is expressly incorporated by reference herein.

The invention relates to a method for selecting, with respect to a physical object, partial objects (referred to herein as “further partial objects”) whose designs are affected by definitions for a first reference element on a first partial object of the physical object. A preferred field of application of the invention is the planning of tolerances for bodies of motor vehicles including that of devices for their manufacture, the planning comprising a plurality of phases of the process of producing a product.

In what follows, “partial objects” is a generic term for the components, modules, units, assemblies and devices which are to be constructed. Devices required for manufacturing or combining other partial objects are referred to as “geostations”. All the partial objects form together a “physical object”. “Reference elements” is a generic term in particular for “reference surfaces” and “reference points”, and “reference points” is a generic term for “locating points”, “measurement points” and “holding points”. Each reference element is associated with precisely one partial object.

During computer-supported design of a physical object composed of a plurality of partial objects, it is necessary to define tolerances of the partial objects. This task is referred to as tolerance modeling and is an important part of tolerance planning. It is necessary to determine how the tolerance of each partial object affects the tolerance of other partial objects, and ultimately of the physical object. During tolerance planning it is necessary to examine the question as to which tolerances the physical object will have as a function of the tolerances of the partial objects.

For example, tolerances of the physical object are determined using statistical assumptions about the tolerances of the partial objects, or whether all the partial objects exhaust their tolerances. For this purpose, it is also necessary to take into account the effects of tolerances on devices which are used during the fabrication and the assembly of the partial objects.

A field of application of tolerance planning is the manufacture of the shell of bodies for motor vehicles.

“Tolerance” is understood as the magnitude of the permitted deviation from a predefined value. The international standard ISO 1101 and the German standard DIN 1101 define the term “design and position tolerance” of an element as the zone in which this element (area, axis, central plane) must lie.

Tolerances are related to reference planes. Reference planes are defined by reference points. Reference points are in particular the points on a clamping device at which components and assemblies are secured in the device, as well as holes and elongated holes in the components which have the purpose of holding the component in a device.

Complex physical objects are constructed in parallel by a large number of employees, specific employees are responsible for specific partial objects. For tolerance planning, these employees are to be provided with information about tolerances. It is necessary to provide each employee with information about “his” partial objects and about influences from the outside and on the outside.

During tolerance planning CAD (Computer-Aided Design) models of the partial objects are usually formed. Information about tolerances is included in CAD models. The assembly sequence is then defined. A tolerance analysis is then carried out, usually by means of tolerance simulations. Commercial tools are available for these steps. Nevertheless, a large amount of work by human employees is necessary for each step.

The results are extensive records with results of simulation runs. A large amount of human work is necessary to obtain the required information for a specific component, and the required information about the effects on other components or on devices. For this purpose it is necessary to look through the records and human employees have to combine results and compare them with the CAD models and the assembly sequence.

Martin Bohn, “Toleranzmanagement im Entwicklungsprozess [Tolerance Management in the Development Process]” Dissertation, University of Karlsruhe, Fakultät für Maschinenbau [Engineering Faculty], 1998, discloses a procedure according to which human employees identify the tolerance-related variables and define the tolerances. These definitions are made continuously through a plurality of phases of the process of producing the product. A procedure according to which tolerance simulations are carried out and human employees evaluate the results of said simulations is described. On the other hand, there is no description of how to automatically determine which other partial objects are affected by definitions for a specific partial object like.

During the computer-supported design, the clamping and securing concept for the physical object also has to be defined. A “clamping and securing concept” often includes a “holding concept”, “orientation concept”, “reference element concept” and/or a “locating point concept”. In particular, a clamping and securing concept determines how, and by means of which devices, partial objects are clamped and secured during assembly.

Sukan Lee and Chunski Yi: “Tolerance Analysis for Multi-Chain Assemblies with Sequence and Functionality Constraints”, Proceed. 1997 IEEE Int. Conf. on Robotic and Automation, April 1997, pp. 927-932, describes a method for determining the assemblability of a product statistically. The product is composed of parts. Parts have reference elements (“features”). A reference element can have geometric or position tolerances. The assemblability is defined as the probability of combining the parts successfully to form the product, provided that the parts are fabricated in such a way that all the tolerances are complied with.

For an individual reference element it is possible to define a restriction, and dependencies can be defined between two adjacent reference elements (“mating features”). These restrictions and dependencies are referred to as “constraints”. “Geometrical constraints”, “functional restraints” and “assembly sequence constraints” are distinguished. Many tolerances can be compensated by clearances between two adjacent reference elements. A permitted clearance and a functional dependence between two adjacent reference elements defines an adjustable distance (“adjustable displacement”) between them. Adjustable distances increase and tolerances decrease assemblability.

The dependencies between the reference elements are represented in Sukan Lee and Chunski Yi by a non-directional dependence graph (“feature graph”). One node of this graph represents a part or reference element and its spatial position (“coordinate frame”), one edge represents a dependence between the spatial positions of two adjacent reference elements or of a part and a reference element. A cycle (“parallel chain”) is a path (“chain”) in the graph whose starting point and end point correspond. The case in which the dependent graph is coherent and comprises at least two cycles (“multichain”) is treated. An adjustable distance is represented by a three dimensional body, preferably an ellipsoid. In order to test whether the parts and reference elements of a cycle can be assembled, the cycle is cut in a virtual fashion at a node N_G so that two paths (“serial chains”) are produced. The tolerances and adjustable distances are propagated along both paths. Ellipsoids are determined for the spatial position of reference elements of each path. It is tested whether the two ellipsoids which are determined for a reference element on the basis of the two paths overlap or not. If they overlap for all the nodes of the cycle, the parts and reference elements of the cycle can be assembled, and otherwise they cannot.

The tolerances and adjustable distances are treated as stochastic variables with normal distribution. The calculations of the geometric bodies are carried out approximately by means of Monte-Carlo simulations by generating and “propagating” values for the tolerances which are random in accordance with the probability distribution. An algorithm is proposed which determines the assemblability as a number between 0 and 1 for a “multi chain”. The assemblability can be used to find a good assembly sequence in which various possible assembly sequences are evaluated by the respective resulting assemblability, or in order to evaluate tolerance predefined values.

Sukan Lee and Chunski Yi do not disclose how the dependence graph is generated. Furthermore, there is no disclosure of how the decision as to when two reference elements are adjacent and influence one another (“mating features”) is arrived at. All that Sukan Lee and Chunski Yi state is that an expert in the field creates the dependence graph manually. The result thus depends on his experience and intuition and is not reproducible. There is the risk of errors being made or of the result being incomplete in the sense that an influence of a partial object on a further partial object is not taken into account in the dependence graph. This risk is then particularly high if the product is composed of hundreds or even thousands of parts and reference elements, which may be the case with the body of a motor vehicle.

R. Söderberg: “Robust Design by Support of CAT Tools”, Proceed. 1998 ASME Design Engineering Technical Conferences, Sep. 13-16, 1998, Atlanta, pp. 1-11, available at http://www.mvd.chalmers.se/˜lali/3dtm/dac5633.pdf (searched on 3.27.2002) explains methods for generating a robust design and for assigning tolerances to reference elements. The function of a product is decisively influenced by product characteristic variables (“product key characteristics”). These product characteristic variables, for example measurements between two measurement points, often depend on geometric characteristic variables of individual parts or design elements of a product. For example, the product characteristic variable of the door gap of a car depends on a plurality of independent characteristic variables (“input parameters”) of the door, frame, suspension and entire body shell. The object of the robust design is summarized in Söderberg to the effect that a product characteristic variable should depend on as few independent characteristic variables as possible and as few interactions between the characteristic variables as possible should occur. An example is used to explain how a designer modifies a design and fabrication of a three-component vehicle base to the effect that the product characteristic variable of the overall width depends on a single independent characteristic variable instead of on three. In order to reduce the complexity of tolerance planning for a three-dimensional design, the 3-2-1 locating point model (“3-2-1 model”) is presented. Here, six locating points (“locators”) are defined, specifically at first three points in a plane, then two further points outside this plane and then the sixth point. These six locating points restrict the six degrees of freedom (three translations, three rotations).

Söderberg proposes that commercial software tools for tolerance planning (“computer-aided tolerancing”) be used to determine which independent characteristic variables of reference elements (“feature variation”) have which relative influences on one product characteristic variable (“contribution analysis”) in each case. For this, Monte-Carlo simulations are carried out during which in each case one independent characteristic variable which is to be investigated within the predefined tolerance is varied and all the other independent characteristic variables remain the same. This does not require complete designs of all the parts of the product but rather only the geometry of the interfaces between parts and reference elements, in particular spatial position and direction of the variation of locating points and spatial extent of parts.

The tolerance simulation is carried out with the objective of determining the influence of independent characteristic variables. The locating points and interface geometry are then modified by employees in such a way that after the modification fewer independent characteristic variables with a large degree of influence on the product characteristic variables are present than before. This modification requires creativity on the part of employees; there is no mention of schematization or automation.

The tolerance simulations which are presented in Söderberg require information as to which reference elements influence which other reference elements or are compatible with which other reference elements. There is no disclosure of how this information is generated.

H. Johannesson, R. Söderberg: “Structure and Matrix Models for Tolerance Analysis from Configuration to Detail Design”, Accepted for publication Journal Research in Engineering Design, Vol. 12, 2000, pp. 112-125, available at http://www.mvd.chalmers.se/˜lali/3dtm/riedhjrs.pdf (searched on 3.27.2002), presents the 3-2-1 locating point model in more detail. Each part has at most one system of locating points (“master locating system”, ↑P-frame”) without tolerances, which positions the part in the product. The part may have a plurality of positioning points (“↓P-frame”) in which the part positions other parts. Geometric dependencies for the product can be decomposed into those for individual positioning points. A stability matrix A connects a vector x of properties of locating points with a vector y of resulting statement of position in the form y=A*x. The stability matrix can be used to examine the degree of coupling between various characteristic variables, and the robustness.

H. Johannesson and R. Söderberg propose an approach for connecting from the top down functional requirements to the geometry, for example to positions of components with design parameters. An employee models which functional requirements are fulfilled by which design parameters and breaks up the product, for example a vehicle, in virtual fashion into subsystems and components. The employee creates a directional graph for the functions and designs (“function-means hierarchy”) which links design parameters of one plane to functional requirements of the next plane. Tolerance chains which indicate the dependencies between various components, between components and peripheral conditions and also between different peripheral conditions can be derived from the directional graph. Tolerance simulation is then used to automatically determine which influence which design parameters have on functional requirements made of the product.

H. Johannesson and R. Söderberg do not describe how the “function-means hierarchy” is generated. Only the way in which the dependencies between functional requirements and design parameters are created manually is indicated. It is necessary in particular here to determine manually the other reference elements which a specific reference element influences. This is susceptible to faults in particular with respect to extensive products, easily gives rise to gaps and overlooked relationships and cannot be carried out economically.

One object of the invention is to provide a method—which can be carried out automatically—for selecting further partial objects (of a physical object) whose designs are affected by definitions for a first reference element on a first partial object of the physical object. The method is intended to reduce the risk of losing the consistency between designs of the partial objects, and thus the design of the physical object, when there are modifications to the first reference element. Furthermore, a device is to be provided for carrying out the method.

This and other objects and advantages are achieved by the method according to the invention, in which the physical object which is composed of the first partial object and at least one further partial object is predefined. The first partial object is predefined as a previously selected partial object, and the first reference element which is associated with the design of the first partial object is predefined as a previously selected reference element. Each partial object of the physical object can be selected as a first partial object, and each reference element on the first partial object may be selected as a first reference element. Furthermore, a design of the physical object is predefined. It includes designs of the first partial object and of the further partial object, the design of each of these partial objects preferably comprising the spatial extent and the spatial position of the partial object. The design of the first partial object also includes the first reference element and the spatial position thereof. The design preferably specifies the spatial position of the first reference element in relation to the first partial object. Furthermore, an assembly sequence is predefined, said sequence defining which partial objects of the physical object are combined in which order using which other partial objects.

In the method according to the invention, for the first reference element, target objects are searched for among those further partial objects that occur after the first partial object in the assembly sequence. A further partial object which occurs after the first partial object in the assembly sequence is then a target object for the first reference element if it holds and/or secures the first partial object in the first reference element.

The method may provide one or more target objects or else the result that there is no target object for the first reference element in the design state which is taken into account for the determination.

In one embodiment of the invention, the spatial position of the first reference element is compared with the spatial extent and position of a further partial object which occurs after the first partial object in the assembly sequence. In addition, the direction which is restricted by the first reference element is compared with the spatial orientation of the further partial object. The spatial orientation of a surface is understood to refer to the direction of a normal vector which is a vector which is perpendicular to the surface. If none of the comparisons provides a difference which is greater than a predefined limit, the further partial object is considered to be a target object, (i.e., it holds and/or secures the first partial object in the first reference element).

According to another embodiment of the invention reference elements of the design of at least one further partial object are taken into account in the determination of target objects and compared with the first reference element. It is tested whether the first reference element is compatible with the further reference element. If so, it is decided that the partial object whose design comprises further reference element is a target object for the first reference element.

The knowledge of the target objects is required in order to ensure that the first reference element matches the partial objects which hold and/or secure the first partial object at least temporarily during the fabrication, and in order to ensure that the first partial object matches the further partial objects to which it is connected in a detachable or non-detachable fashion. This knowledge reduces the risk of the designs of two partial objects not matching one another. If such incompatibilities between the designs of various partial objects are not discovered until after the design has been completed or even during ongoing operation, for example during the fabrication and the assembly of partial objects or even not until during operation, modification designs must be carried out, typically great time pressure, or it is even necessary to retrofit already fabricated partial objects, which can give rise to considerable costs.

The method according to the invention indicates a way of determining, in a reliable, repeatable, systematic, rapid fashion, which can therefore be carried out in a short time and cost-effectively, effects of design decisions, in an efficient manner even if the physical object is composed of hundreds or thousands of partial objects or if the designs of these partial objects are generated and modified by a large number of different employees. A particularly large advantage is obtained if the employees working on the partial objects operate in a spatially distributed and chronologically parallel fashion. Even in this case, designs of a large number of partial objects have to be matched to one another quickly, and at the same time each employee is only familiar with the designs of a small number of partial objects. The method according to the invention is preferably carried out again after each relatively large modification to a partial object and/or when a new design state for the design of the physical object is reached.

A further advantage of the method according to the invention is that it can be applied early in the process of producing a product. It is not necessary for a design to have already been generated for each partial object of the physical object before the method is applied. It is sufficient for designs of the partial objects which follow in the assembly sequence to be present, including a design of the target object. These designs do not necessarily need to be generated completely already, but rather only to the extent that it is possible to decide which are the target objects and the comparisons and tests provided by the refinements can be carried out.

A reference element is either a reference point or a reference plane. Each reference point is preferably a locating point or a holding point, and each reference plane is a locating surface or a holding surface.

The physical object preferably comprises two types of partial objects: those which are associated with a further physical object, and those which are used as devices in the manufacture and the assembly of the first type of partial objects to form the further physical object. The first type of partial objects is assembled for the time for which the further physical object is used, and the second type enters into an interaction with partial objects of the first type for the time during which the further physical object is manufactured. The two types of partial objects are preferably designed together in order to ensure at an early point that they match.

The further physical object is, for example, a body of a motor vehicle. The further partial object is a device or a component of a device which the first partial object is in contact with, at least temporarily during the manufacture of the body in the first reference element. The physical object is then composed of the body and the devices for manufacturing the body. It generally comprises hundreds of partial objects which have to fit together.

The method according to the invention is preferably used for tolerance planning and/or for defining the clamping and securing concept and/or holding concept and/or orientation concept and/or reference element concept and/or locating point concept, specifically preferably during the computer-supported design of a physical object.

The testing as to whether a further partial object is a target object is preferably carried out for each partial object which occurs after the first partial object in the assembly sequence. Another refinement provides for the testing in step b) to be repeated until either at least one target object has been determined or until it is apparent that there is no target object for the first reference element among the further partial objects occurring after the first partial object in the assembly sequence.

Preferably two types of target objects are distinguished, namely direct target objects and indirect target objects. Here, no further target object for the first reference element occurs between the first partial object and a direct target object in the assembly sequence, while at least one further target object for the first reference element occurs between the first partial object and an indirect target object. Direct and indirect target objects are distinguished from one another by means of this property. The first partial object is held and/or secured directly by means of a direct target object. By contrast, an indirect target object holds a direct target object, and thus holds the first partial object indirectly and/or secures it. Preferably, in addition for at least one target object a decision is taken as to whether it is a direct or an indirect target object for the first reference element.

The design of the first partial object preferably comprises a definition of how far away a target object may be at the minimum or at the maximum from the first reference element. For a further partial object which occurs after the first partial object in the assembly sequence, the distance between this further partial object and the first reference element is determined, and compared with the defined distance.

In another embodiment of the invention, the spatial orientation of the reference point with respect to the further partial object (that is, the direction of a normal vector to the surface of the partial object in the first reference point) is determined. The vector is preferably a unit vector defined by specifying an x component, y component and z component. This spatial orientation is compared with the direction which is restricted by the first reference point. With respect to a reference point, the embodiment takes into account the possibility that the first reference point is not located on the surface of the further partial object, and there are therefore different normal vectors which run through the first reference point.

The comparison is preferably carried out if the first reference point is located on or near to the surface of the further partial object. If the direction of the normal vector differs from the restricted direction by more than a predefined limit, the selected partial object is not a target object for the first reference point.

An embodiment of the method as described below defines, as tested in step b), whether the first reference element is compatible with the further reference element. The embodiments here define necessary criteria for the compatibility. If a criterion is infringed, the reference elements are not compatible with one another.

The two reference elements are evaluated as not compatible at least when their spatial positions do not correspond to one another. A spatial position through an x coordinate, y coordinate and z coordinate is preferably described. As it is necessary, for example, to take into account rounding errors and computational accuracies, the definition is made of when two spatial positions are evaluated as corresponding to one another.

Another feature of the invention takes into account the possibility that both reference elements are reference points for each of which a normal vector is determined. In the first reference point, the one normal vector is perpendicular to the surface of the first partial object. In the further reference point, the other normal vector is perpendicular to the surface of the further partial object. The designs of the first partial object or of the further partial object include the normal vectors, or they are determined from the designs when required. The vector is preferably a unit vector defined by specifying an x component, y component and z component. The two reference points are evaluated as not compatible at least when these normal vectors do not correspond. Precisely as for the comparison of spatial positions, there is also a definition of when two vectors are to be evaluated as corresponding to one another for the comparison of vectors.

The method according to the invention can take into account the possibility that both reference elements are reference surfaces. For both reference surfaces a spatial orientation in the form of a normal vector to the reference surface is determined in each case. The two reference surfaces are evaluated as not compatible at least when these normal vectors do not correspond.

According to the invention, there can also be a definition of the direction in which the first reference element restricts the spatial movement of the first partial object. There is also a definition of the direction in which the further reference element restricts the spatial movement of the further partial object. Each restriction is preferably one in the x direction, y direction or in the z direction. The two reference surfaces are evaluated as not compatible at least when the restricted directions do not correspond.

It is also possible according to the invention to define the type of the first reference element and the type of the further reference element. Four possible types of reference elements are locating points, holding points, locating surfaces and holding surfaces. The two reference elements are evaluated as not compatible at least when these types do not correspond.

The design of the first partial object may comprise a design tolerance or position tolerance for the first reference element, and the design of the further partial object may comprise a design tolerance or position tolerance for the further reference element. The two reference elements are evaluated as not compatible at least when the two tolerances do not correspond.

The design of the first partial object can comprise a definition of how far away a target object may be at the minimum or at the maximum from the first reference element. As a result, a lower or upper limit is predefined. The two reference elements are evaluated as not compatible at least when their distance from one another is greater than the defined maximum distance or smaller than the defined minimum distance.

A further criterion can be applied if both reference elements are reference points. The definition is made of the direction in which the first reference point restricts the spatial movement of the first partial object. The spatial orientation of the further reference point, that is a normal vector to the surface of the further partial object in the further reference point, is defined. For example, such a normal vector is defined in the design of the first partial object. The direction of this normal vector is compared with the direction which is restricted by the first reference point.

Those of the individual tests which are described above whose preconditions are fulfilled are preferably carried out in succession. If an individual test reveals that the two reference elements are not compatible with one another, the next individual test is not carried out. If either correspondence is defined in all six comparisons or the individual test cannot be carried out due to lack of corresponding geometric information, the two reference elements are compatible with one another.

A complete design of a partial object is composed of a very large number of information items. The comparison of designs may require a lot of running time and computing capacity. In order to reduce this expenditure, one refinement provides for the reference elements firstly to be extracted from the designs of the partial objects and then recorded. In the process, in particular geometric information about the reference elements and references to the partial objects with which the reference elements are associated is extracted. The extracted reference elements are used exclusively for testing to determine whether the further partial object holds and/or secures the first partial object in the first reference element.

One preferred embodiment provides for a global identifier of a reference element to be composed of at least three individual identifiers, specifically of

an identifier of that partial object with whose design the reference element is associated;

an identifier with which the reference element is distinguished from other reference elements on the same partial object; and

an identifier for the type of the reference element.

The identifier used for a partial object is, for example, its serial number and a letter which distinguishes components, assemblies, units and devices from one another.

The global identifiers are very informative. It is possible then in particular for an employee to conclude the position and significance of a reference element from the global identifier of said reference element, which is given, for example, in a paper printout. An employee can more easily understand the design which another employee has generated. In addition, information about the reference element can be derived automatically from a global identifier by means of a suitable definition.

Inventive global identifiers are preferably assigned not only for reference elements but for any design element. “Design elements” is a generic term for “reference elements” and comprises in particular locating points, holding points, measurements, measurement points and dimensions. The global identifiers distinguish in particular different types of design elements.

All the design elements are preferably provided with such global identifiers and as a result denominated in accordance with a uniform nomenclature. As a result, the design elements can easily be found again, for example, in results of tolerance simulations because the names in accordance with the uniform nomenclature are very informative. All the global identifiers for design elements can be generated automatically.

The information which is generated according to the invention and which indicates that the first design element is compatible with the further design element is coded in the global identifier of the first design element and/or of the further design element. For the further reference element, a global identifier is generated which refers to the first reference element in that it comprises an identifier for the first partial object, an identifier which distinguishes the first reference element from further reference elements of the design of the first partial object, and an identifier for the type of the first reference element. Conversely, a global identifier which refers to the further reference element is generated for the first reference element. Such a global identifier for the first reference element may be expanded by adding an identifier for a further partial object. If a direct target object is found, the global identifier for the first reference element is expanded by adding an identifier for this direct target object.

Embodiments of the invention are particularly advantageous if the method is carried out a plurality of times. When the method is carried out, a global identifier for the first design element is generated, and in either this iteration or a further iteration, further partial objects are selected as a function of the global identifier of the first reference element. Preferably only those partial objects whose identifiers are included in the global identifier of the first reference element are selected.

This also is applicable for further reference element instead of the first reference element. When the method is carried out, a global identifier for the further reference element is generated, and in either this iteration or a further iteration the global identifier is taken into account in the testing of further partial objects. The further reference element is preferably tested for compatibility with the first reference element only if the global identifier of the further reference element comprises an identifier for the first partial object, an identifier which distinguishes the first reference element from other reference elements on the first partial object, and an identifier for the type of the first reference element.

The embodiments of the invention which have been described thus far provide that only existing reference elements are compared when determining target objects. This requires the reference elements to have been generated before the method according to the invention is applied. The risk of errors is reduced if, instead, designs of partial objects are expanded by adding compatible reference elements by means of the development of the method according to the invention.

The method also teaches how such a reference element is generated automatically. If a target object is selected for the first reference element, a further reference element which is associated with the design of this target object is generated automatically, in such a way that it is compatible with the first reference element of the design of the first partial object. The further reference element which has been generated automatically comprises an identifier and the spatial position in relation to the selected target object. One possible result of this embodiment is that it is not possible to generate a further reference element which is associated with the target object and is compatible with the first reference element.

The automatically generated reference element is preferably associated with the design of a direct target object and it is compatible with the first reference element according to defined criteria. Further, the first reference element and the further reference element may be either both reference points or both reference surfaces. In addition, when the further reference element is generated, the direction of the normal vector, the restricted direction and the type of the first reference element are transferred so that the first reference element and the further reference element correspond in terms of

their spatial positions;

normal vector to the surface of the respective partial object or the respective reference surface;

direction in which the spatial movement of the respective partial object is restricted; and

type of the reference element.

It is tested here whether it is at all possible to generate a further reference element which is compatible with the first reference element and which is associated with the design of the direct target object.

Before the documentation is generated, a reusable template for the documentation is preferably generated. The documentation is generated by virtue of the fact that a copy of this template is filled in. Using a reusable template is advantageous in particular if the method according to the invention is carried out a plurality of times, and in doing so a plurality of documentation items are generated, for example for various partial objects or reference elements or for various design states of the design of a partial object.

The method according to the invention is advantageous in particular if the physical object comprises a large number of partial objects whose designs are generated and modified in parallel by a large number of employees. So that the designs of the partial objects match one another, those employees whose designs are affected by a modification are preferably informed about the modification. For this reason, in one embodiment it is tested, with respect to at least one target object which is determined, whether the target object is linked to an address. A message comprising the effects determined according to the invention is sent to this address.

An addressee of this message is, for example, an employee who is responsible for the design of the target object. The message comprises an identification of the first reference element and one of the target object which is determined. Global identifiers are preferably used for this. If a plurality of target objects have been determined, a plurality of messages are preferably generated and sent to various addresses.

The precondition here is that at least one further partial object is linked to an address. With respect to at least one target object it is tested whether the target object is linked to an address. If this is the case, a message which comprises an identifier of the first reference element and an identifier of the target object is generated. Documentation is preferably firstly generated, as just described. A message which comprises this documentation is then generated and sent to the address which is linked to the target object.

In order to find out the address to which such a message is sent, the partial objects of the physical object are linked to addresses. This address is preferably an e-mail address, and the message is sent in electronic form over a message network, for example an Intranet. The linking of partial objects to addresses is preferably generated by automatically linking two tables to one another:

a table which connects each partial object to the employee who is responsible for generating and changing its design; and

a further table which connects each employee to an e-mail address.

The method according to the invention provides for a partial object of the physical object to assume the role of the first partial object, and for a reference element of the first partial object to assume the role of the first reference element. According to the invention, target objects are determined for this first reference element. A systematic procedure is to carry out this method for all the reference elements. The method according to the invention is preferably carried out repeatedly, specifically at least once for each partial object of the physical object and once for each reference element of the partial object, each partial object assuming the role of the first partial object at least once, and each reference element assuming the role of the first reference element at least once.

All the reference elements for which no target object has been determined are listed by means of one development of the embodiment. The denomination of these reference elements provides information as to the locations at which the designs of the partial objects of the physical object are still incomplete or contradictory.

The previous embodiments of the inventions determine target objects for the given first reference element. Moreover, in particular for tolerance planning it is important to know which measurements on the physical object are influenced in what way by the first reference element. One embodiment teaches how this information is generated. A design tolerance, position tolerance or dimensional tolerance is defined for the further reference element. The design of the physical object comprises information about at least one measurement on the physical object. If the first reference element is compatible with the further reference element, the following subsequent steps are carried out:

Tolerance simulation is carried out in which the further reference element and the measurement are taken into account.

In addition, the results of this tolerance simulation are recorded.

Which measurements on the physical object are influenced by the further reference element is determined from the recorded results.

Which measurements on the physical object are influenced by the first reference element is derived therefrom.

A method for fabrication planning uses the method according to the invention to implement a continuous process chain. In particular, the following steps are carried out here:

A parts list is created for the physical object (step i).

A design which comprises designs for the partial objects is created for the physical object (step ii).

Design elements of the partial objects are generated as part of the designs of the partial objects, at least one first reference element being generated (step iii).

An assembly sequence which defines in which order which partial objects are assembled using which other partial objects is created (step iv).

The method according to the invention is carried out at least once. Target objects for the first reference element are searched for among the partial objects for which a design exists (step v).

The method just described is preferably used for tolerance planning for the physical object. In step iii, in particular reference elements, measurement points, measurements and tolerances for design elements are generated. A tolerance simulation for the physical object is carried out between steps iv and v. In step v, there is additionally a determination of which influences the first reference element has on which partial objects.

The method according to the invention is preferably carried out with a device which comprises means for comparing geometric information about partial objects which permit reference elements to be compared.

The method according to the invention can also be carried out using a computer program product which can be loaded directly into the internal memory of a computer, and comprises software sections with which the method according to the invention can be carried out if the product runs on a computer. In particular, this computer program product can be stored on a web server and transferred directly into an internal memory of a computer via the Internet or via an Intranet, the computer being a client.

The method according to the invention can also be carried out using a computer program product which is stored on a computer-readable medium and which has computer-readable program means which cause the computer to carry out the method according to the invention. The medium is, for example, a set of diskettes, of CDs, mini disks or of tapes or a storage unit which is connected to a PC by means of an interface, for example a USB port or an SCSI interface.

Other objects, advantages and novel features of the present invention will become apparent from the following detailed description of the invention when considered in conjunction with the accompanying drawings.

### BRIEF DESCRIPTION OF THE DRAWINGS

FIG. 1 is a flowchart of an exemplary embodiment of the method according to the invention;

FIG. 2 is an illustration of primary, secondary and tertiary planes of partial objects according to the 3-2-1 principle (prior art);

FIG. 3 is an illustration of the indication of tolerances (prior art);

FIG. 4 is an illustration of an assembly sequence;

FIG. 5 is an illustration of the determination of a target object;

FIG. 6 shows definitions for six locating points of a partial object;

FIG. 7 is an illustration of the information about a component which is generated according to the invention, and further information about a component; and

FIG. 8 is an illustration of the information about a measurement which is generated according to the invention and further information about a measurement.

### DETAILED DESCRIPTION OF THE DRAWINGS

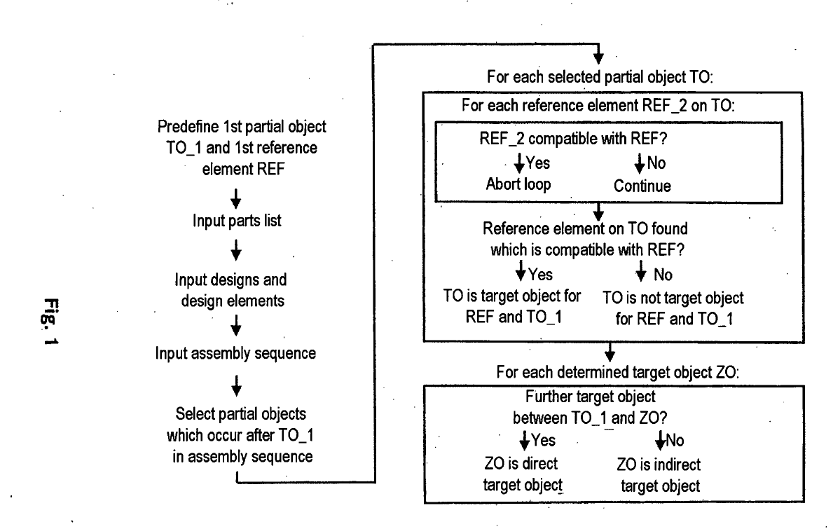

FIG. 1 shows a flowchart for an exemplary embodiment of the method according to the invention. The tolerance planning or the definition of a clamping and securing concept serve as exemplary fields of application. The individual steps are explained below.

The method for selecting further partial objects is advantageously carried out by means of a computer program on a data processing system. When the method according to the invention is applied, the partial objects are selected by means of input information. This input information is generated in advance and stored in data storage devices.

An embodiment of the invention teaches a specific configuration of this input information. This input information, specifically the CAD models of the partial objects, the assembly sequence and the definitions of the reference elements are stored in the following data storage devices:

A first data storage device contains information as to which partial objects the physical object is made up of, and with management information about the partial objects. This includes, for example, the definition of which partial objects form the further physical object, and which partial objects are devices. A parts list which lists the partial objects of the physical object together with their management information is preferably stored in the first data storage device.

A second data storage device is composed of the CAD models of the physical object and those partial objects which are specified in the parts list. Such a CAD model contains geometric information about the partial object, which information comprises the spatial extent and the spatial position of the partial object.

A third data storage device contains geometric information about the reference elements of the partial objects. In particular, this third data storage device contains an identifier and the spatial position of each reference element and in addition the spatial orientation of each reference surface. The spatial orientation of a surface is specified, for example by means of a normal vector, that is a vector which is perpendicular to the surface.

A tree structure for the assembly sequence is stored in a fourth data storage device. This assembly sequence specifies in what order which partial objects is assembled using which other partial objects.

A fifth data storage device contains the results of the tolerance simulations.

The information which is generated according to the invention, in particular about the selection of the partial objects, is stored in a sixth data storage device.

The data processing system has at least temporary read access to the first five data storage devices and write access to the sixth data storage device.

The data storage system may be, in particular, permanent data memories or main memories of data processing systems. They can for example, all be associated with the same computer or with different computers which are connected in a local computer network or an Intranet. The data processing system has continuous and/or temporary read access to the first five data storage devices, and continuous or temporary write access to the sixth data storage device.

In the text below there is first a description of which information fills the first five data storage devices and how this information is generated.

In a system for performing product data management (PDM), also referred to as engineering data management (EDM), a parts list is input which comprises the information indicating the partial objects from which the physical object is composed. In addition, management information about the physical object and its partial objects is input.

A design of the physical object and its partial objects is created. This is done by designers creating a CAD model of each partial object, specifically both of partial objects of the further physical object and of devices and their components. A CAD model into which the CAD models of its partial objects are associatively imported is also made of the further physical object in its entirety. The design elements which are required for the tolerance planning are described in these CAD models. “Design elements” is a generic term in particular for reference points, reference surfaces, measurement points, dimensions and measurements on the physical object and its partial objects.

As part of the design, reference elements are defined for the partial objects. Reference elements are reference points and reference surfaces (that is, in particular the points or surfaces at which a partial object A of the further physical object is secured and/or held by a device or another partial object A of the further physical object while the further physical object is being manufactured). The partial object A is preferably a component, and the other partial object B is an assembly or a device.

Six reference points are required to restrict the six degrees of freedom of a rigid body in space in a statistically determined fashion. The first three reference points cover the primary plane. The next two reference points define the secondary plane which is perpendicular to the primary plane. The last reference point defines the tertiary plane which is perpendicular to the two other planes. The primary, secondary and tertiary planes are perpendicular to one another in pairs. The three planes preferably have parallel axes, i.e. the primary plane is either perpendicular to the x axis or the y axis or the z axis, and the same applies to the secondary and tertiary planes. The primary, secondary and tertiary planes can however also be oriented with non-parallel axes.

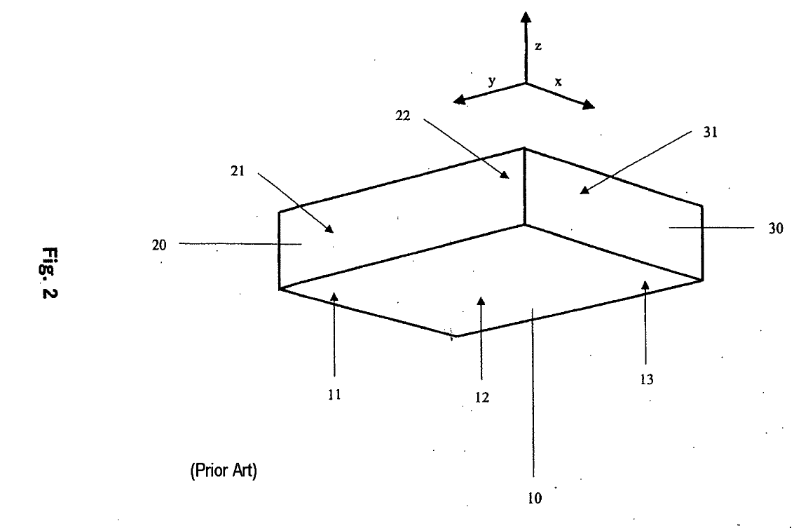

FIG. 2 illustrates the six reference points and the three planes according to the 3-2-1 principle. The primary plane is designated by 10, the secondary plane by 20 and the tertiary plane by 30. The reference points 11, 12 and 13 cover the primary plane 10, the reference points 21 and 22 cover the secondary plane 20, and the reference point 31 covers the tertiary plane 30.

It is not necessary to define which further partial object secures the partial object A in a specific reference point. This information is instead determined automatically by the method according to the invention by selecting target objects. This further partial object is the direct partial object for the partial object A and to a predefined reference element. The method preferably also finds indirect target objects, that is to say the partial objects which themselves hold the direct target object.

Commercially available CAD tools such as CATIA in conjunction with the tolerance-specific application “functional dimensioning and tolerancing” permit the user to integrate design elements for tolerance planning into CAD models and to define the tolerances for, and further properties of, these design elements. In particular, reference points and reference surfaces can be modeled in this way. Examples of such reference points with tolerances are a locating point with a positional tolerance in the x direction of a coordinate system and the dimension with a tolerance of a component.

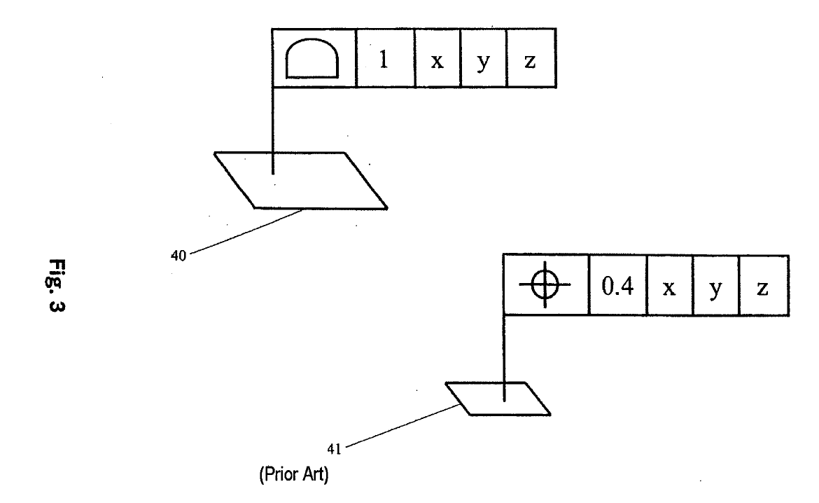

FIG. 3 is a customary illustration of the tolerance of the profile of a surface 40 (on the left), as well as of the tolerance of a position 41 (on the right). The profile of the real surface must lie within two ideal parallel surfaces with a spacing of 1 mm. The position of the point has a tolerance of ±0.2 mm in each case, that is to say a total of 0.4 mm, in the x, y and z directions.

In addition, definitions of measurements are integrated into the CAD models. The measurements include in particular point measurements in the x direction, in the y direction and in the z direction, and gap measurements, angle measurements, offset measurements and distance measurements. For each measurement a definition is made of which measurement points are associated with this measurement.

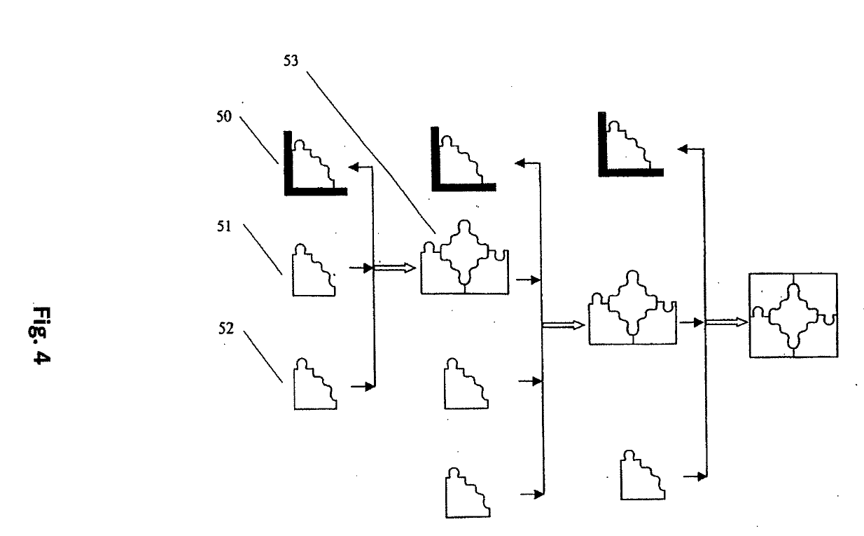

The assembly sequence is defined next. The assembly sequence is a tree structure which indicates the order in which the further physical object is assembled from partial objects, in particular from components and assemblies, and which devices are used when. As a rule, the assembly sequence is multi-staged because assemblies are manufactured from the components, and other assemblies are manufactured from these assemblies, and finally the further physical object is manufactured from these other assemblies. FIG. 4 shows such an assembly sequence. In this example, the component 52 and then the component 51 are first secured in the holding device 50, and the two components 51 and 52 are then permanently assembled to form the assembly 53.

Commercial tools for tolerance simulation permit an employee to create such an assembly sequence. The tool for creating the assembly sequence preferably has read access to a data storage device which comprises a parts list or some other listing of all the partial objects of the physical object. This listing can be generated automatically from the system for PDM or the CAD models.

After the CAD models have been generated with the design elements and the measurements and the assembly sequence has been defined, the next step comprises carrying out a tolerance simulation. The person skilled in the art is familiar with commercial tools for tolerance simulations: for example “Variation System Analysis (VSA)” from “Engineering Animation, Inc” (http://www.eai.com/products/visvsa/classic vsa.html, searched on 6.13.2001) or “Valisys” from “Tecnomatix” (http://www.valisys.com/marketing/product-desc.html, searched on 6.13.2001). For each tolerance-related design element there is a determination of the effects which the fluctuations in the variables which are subject to tolerance have on other variables. This is generally carried out using Monte-Carlo simulations with a large number of simulation runs.

All the variables of design elements of partial objects which are subject to tolerance and which do not depend on other variables of design elements are considered as random variables in terms of the statistics. According to the probability distributions of the random variables, a random number generator generates number values within the permitted range of variation of the variables. Which other dependent variables are influenced by these independent variables is defined by the CAD models of the partial objects and of the assembly sequence. At least the mean value, the variation or standard deviation, a histogram for the variation of the measurement over the value range of the variable, a weighted listing of the influencing factors and the cp value and the cpk value are preferably provided for each measurement MES_{—}1 as a result of the tolerance simulation. An influencing factor may be an independent variable, for example the tolerance of a reference point on a device or a dimension of a component or some other dependent variable, for example the tolerance of another measurement. A percentage, specifically the maximum possible percentage of the influencing factor in the variation of the result of the measurement MES_{—}1 serves as a weighting factor.

In order to be able to carry out such tolerance simulation, on the one hand information about the physical object, the partial objects and the design elements are required and on the other hand information about the assembly sequence is required. The person skilled in the art is familiar with the procedure in which the CAD models of the physical object, all the partial objects and all the design elements are read in and made available for the tolerance simulation. As a result, a large number of information items, in particular geometric ones, which are not required for the tolerance simulation are read in. One advantageous embodiment provides that the required information about specific design elements is firstly extracted from the CAD models and only this extracted information is read in and used for the inventive determination of target objects and for the tolerance simulation.

In the method according to the invention, the input information is acquired from the five data storage devices. The selection of partial objects will be described using the example of a component. Let 1234567 be the serial number of the component for which target objects are selected. The component 1234567 in this example is therefore the first partial object of the method. Management information about 1234567 is acquired from the first data storage device.

The method according to the invention determines at least one target object for each of the six reference points of the component 1234567 by selecting further partial objects, or determines that there is no target object. The term target object for a reference point REF is understood to be a further partial object (in particular an assembly or a device) which secures and/or clamps the component 1234567 in the reference point REF. A direct target object which is the first target object after the first partial object in the assembly sequence, as well as indirect target objects, are preferably determined. It is necessary to take into account the possibility that the component 1234567 is secured in its various reference points by different partial objects. For this reason, a separate determination of the respective target objects is necessary for each reference point of 1234567. Each reference point assumes the role of the first reference element during this determination.

Read access to the third data storage device automatically determines which reference points are associated with the component 1234567. The information about:

the type of the design element, in particular whether it is a locating point, holding point or a locating surface or holding surface. The type of holding, for example direct or indirect holding, is also determined for a holding point;

the spatial position of the reference point, preferably specified by means of x, y and z coordinates;

the spatial orientation of the component 1234567 in the reference point, preferably specified by means of the normal vector (x, y and z coordinates) of the surface of the component 1234567 in the reference point;

the restricted direction, that is the definition of the direction in which the reference point restricts the component 1234567, and whether it is associated with the primary plane, secondary plane or tertiary plane, the restriction being preferably one in the x direction, x direction or z direction; and

the tolerance of the reference point with respect to the component 1234567

is extracted for each of these reference points from the CAD models with its design elements.

The direction which is restricted by the reference point can differ from the spatial orientation of the component in the reference point.

Only one partial object is possible as a target object for a reference point REF, said partial object occurring after 1234567 in the assembly sequence. The assembly sequence thus defines which partial objects are possible for securing 1234567 in the reference point REF. The partial objects are successively compared, in the order specified by the assembly sequence, with the spatial position of the reference point REF, starting at the partial object which comes directly after the component 1234567 in the assembly sequence.

Let 7777777 be a device which occurs after 1234567 in the assembly sequence. Firstly the spatial position of REF is compared with the spatial position and extent of the device 7777777. The spatial position of REF is preferably described by means of an x, y and z coordinate in a coordinate system. The description of the extent and the position of each partial object is predefined by the CAD models. A person skilled in the art knows various methods of describing the geometry of a partial object. One type of description is the fact that the partial object is built up of elementary geometric bodies such as squares and cylinders, and other elementary geometric bodies are subtracted.

In the search for target objects, it is tested, for example, whether the reference point REF lies inside or outside each of these partial objects. In addition it is tested whether the distance between the reference point and the surface of a partial object is not greater than a predefined limit. If the reference point REF lies outside or on the surface of the device 7777777 and the distance from the surface of 7777777 is smaller than or equal to the predefined limit, 7777777 is a candidate for being a target object for REF.

Let PKT be the point on the surface of 7777777 which REF is closest to. The following further tests are carried out for 7777777, for example, in order to determine whether 7777777 is actually a target object for REF:

The spatial orientation (that is, a normal vector to the surface of 7777777 in the point PKT) is determined. For REF there is a definition of the direction in which the spatial orientation of 1234567 is restricted by the fact that 1234567 is held or secured in REF by another partial object. The direction of the normal vector is compared with the restricted direction. The comparison supplies a positive result if the difference between the two directions is below a predefined limit. This limit is, for example, the thickness of the material or the thickness of the wall.

A tolerance is predefined for REF. Said tolerance is compared with a tolerance for 7777777 in PKT.

For REF there is a definition of the type of the partial object which holds or secures 1234567 in REF. For example there is a definition that 1234567 is held directly in REF. This definition is compared with the type of the partial object 7777777. As 7777777 is a device, it holds partial objects directly.

If both additional tests have provided a positive, 7777777 is a target object for REF, and otherwise it is not.

Each target object which is determined in this way for REF is also tested to determine whether it is a direct or indirect target object for REF. During the testing for 7777777, it is tested whether or not a further target object occurs in the assembly sequence between 1234567 as the first partial object and the target object 7777777. If none occurs, 7777777 is a direct target object for 1234567.

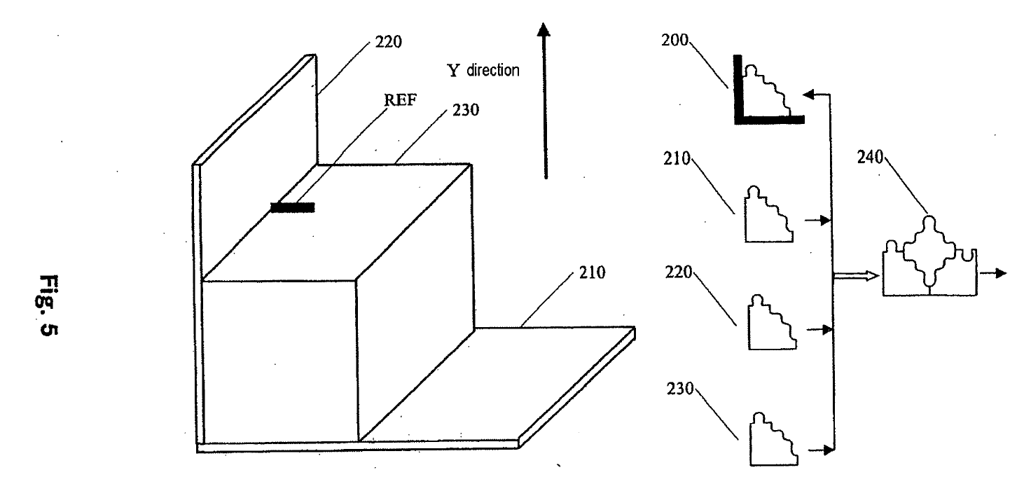

In many situations, it is possible to eliminate comparisons of spatial positions and extents by means of a specific embodiment of the invention and this saves on computer time in particular. The embodiment is illustrated by means of an example using FIG. 5 which shows a detail from an assembly sequence.

In the example, REF is a reference point on the component 230 which assumes the role of the first reference element. From the information about the reference point it is inferred that REF restricts the movement of the component 230 in the y direction (2nd point primary plane) and is a reference point for indirect holding. Indirect holding means: the component 230 is held by means of another component, and not directly by means of the device 200. The components 210, 220 and 230 are assembled to form the assembly 240. From this information and from the assembly sequence it is automatically concluded that only the components 210 and 220 are possible as a direct target object for REF. The spatial position of REF is therefore compared only with the spatial position and the spatial extent of the component 210 and that of the component 220.

One development of the invention provides for REF to be firstly compared with further predefined reference elements on further partial objects. These further reference elements are stored in the third data storage device. For example, the reference elements of all the further partial objects which occur after the first partial object 1234567 in the assembly sequence are determined successively. Each of these further reference elements is compared with the first reference element REF in terms of compatibility. Whenever a further compatible further reference element is found, the further partial object with whose design the compatible further reference element is associated is marked as a target object for REF.

Let 7777777 be a device which occurs after the component 1234567 in the assembly sequence. Let REF_{—}2 be a further reference point of the design of 7777777. The following individual tests are used, for example, to test whether REF_{—}2 is compatible with the first reference element REF:

There is a definition of which type REF is and of which type REF_{—}2 is. In particular there is a definition of whether REF is a locating point, holding point, locating surface or holding surface for direct or indirect holding, and the same is defined for REF_{—}2. If the two types correspond, this individual test supplies a positive result.

The spatial position of REF is compared with that of REF_{—}2. If its Euclid distance is not greater than a predefined limit, this individual test provides a positive result. In addition, it is possible to predefine a minimum distance which is taken into account in the individual test.

There is a determination of the direction of the normal vector which is perpendicular to the surface of the component 1234567 at REF. Furthermore, there is a determination of the direction of a normal vector which is perpendicular to the surface of the device 7777777 at REF_{—}2. The two normal vectors are standardized to the length 1. They specify the orientations of 1234567 at REF and of 7777777 at REF_{—}2. If the two normal vectors do not differ from one another by more than a predefined limit, this individual test supplies a positive result.

There is a definition of the direction in which the spatial movement of 1234567 is restricted by virtue of the fact that 1234567 is held or secured at REF by another partial object. Furthermore there is a definition of the direction in which the device 7777777 restricts the direction of a partial object which 7777777 holds or secures at REF_{—}2. Here, only the x direction, y direction and z direction are distinguished. The two directions which are defined for REF and REF_{—}2 are compared with one another. If they correspond, this individual test supplies a positive result.

The normal vector to the surface of 1234567 at REF is compared with the direction in which 7777777 restricts the spatial movement of a partial object which is held at REF_{—}2. If the restricted direction does not differ from the normal vector by more than a predefined limit, this individual test supplies a positive result.

The normal vector to the surface of 7777777 at REF_{—}2 is compared with the direction in which the spatial movement of 1234567 is restricted by virtue of the fact that 1234567 is held at REF by a further partial object. If the restricted direction does not differ from the normal vector too much, this individual test supplies a positive result.

Individual tests are carried out successively until either all the individual tests are carried out with a positive result—the two reference elements are then compatible with one another—or until an individual test supplies a negative result—the two reference elements are then not compatible with one another, and further individual tests for these two reference elements on these partial objects are not carried out.

In the tests described above, one or more compatible reference elements can be found. However, it is also possible that no compatible reference elements will be found at all. In this case, a compatible reference element is preferably automatically generated—or it is determined that this is not possible. For this, at first a direct target object is firstly determined as described above, and then the point PKT on the surface of the direct target object which is closest to the first reference element REF is determined. A reference element REF_{—}2 whose spatial position corresponds to that of PKT and which is of the same type as REF, or of a compatible type, is generated on a trial basis. The individual tests which are described above are carried out for REF and REF_{—}2. If they all have positive results, a compatible reference element is generated automatically. If an individual test provides a negative result, it is thus determined that no reference element which is compatible with REF can be generated.

One refinement of the invention (claims 5 to 8) teaches how the design elements and thus reference elements are provided with unambiguous global identifiers. The embodiment provides a nomenclature for the design elements. In order to be able to generate quickly and efficiently the information which is required for the tolerance planning or for the definition of a clamping and securing concept, the partial objects and design elements are provided according to the invention with global identifiers. These global identifiers characterize the partial objects and design elements unambiguously. They are evaluated automatically in order to generate the information about partial objects and design elements.

The global identifier of a partial object is composed of a uniquely defined identification, preferably the serial number, and an identifying element which indicates whether it is a component, assembly, a device or some other partial object. For example, A stands for a component, Z for an assembly and V for a device.

The global identifier of a design element, and thus of a reference element, is composed of the following information:

the identifier of the partial object with whose design the design element is associated;

an identifying element which indicates the type of the design element, as a result in particular reference points, reference surfaces, measurement points, measurements and dimensions are distinguished; and

when necessary an identifying element in order to distinguish the design element from design elements of the same type in the design of the same partial object, that is to say in order, for example, to distinguish different reference points or dimensions of the same component.

Therefore, the global identifier of a reference point also specifies:

the direction (x direction, y direction or z direction) in which it restricts the spatial movement of the component;

whether it is associated with the primary plane, secondary plane or tertiary plane; and

the type of the reference point, for example hole, elongated hole or other point for holding a component or assembly or else a point for orienting or averaging. The identifier also distinguishes whether the reference point is one for holding partial objects directly or indirectly. Direct holding of a component is holding in a device, indirect holding is holding by means of some other component or by means of an assembly.

Two examples of the global identifiers:

A hole on the component with the serial number 1234567 is provided with the global identifier A1234567_L_I_X4Z6, the hole serving as a reference point and restricting the spatial movement of the component in the x direction (1st point secondary plane, therefore 4th restriction) and z direction (tertiary plane). A here is the identifying element for a component, L that for a hole and I that for indirect holding.

A reference point on the clamping device V1212121 which restricts the spatial movement of a held component in the y direction (1st point primary plane, therefore 1st restriction) is provided with the global identifier V1212121_F_S_Y1. F identifies a holding point here, and S identifies a direct holding.

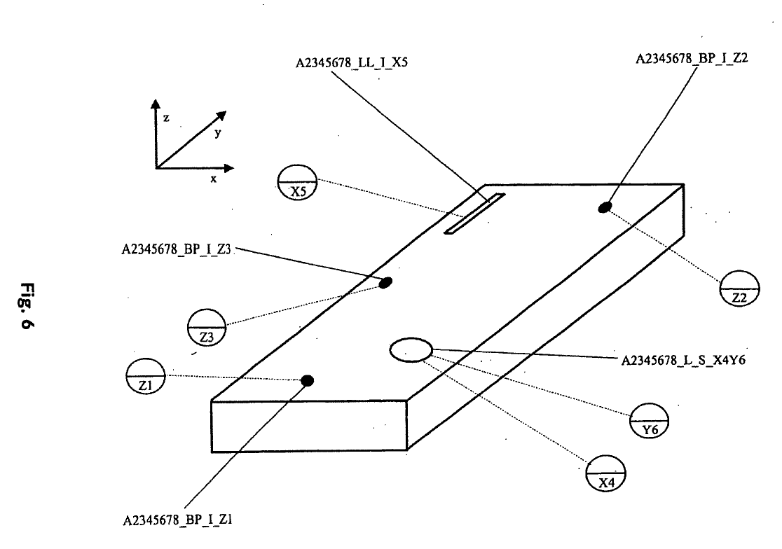

FIG. 6 shows an example of six reference points of a cuboid with the designation A2345678, specifically an elongated hole with one locating point and a hole with two locating points, as well as three further locating points. LL identifies an elongated hole, L a hole and BP some other locating point. The primary plane is the z plane, the secondary plane the x plane and the tertiary plane the y plane. The circles which are connected to locating points by unbroken lines illustrate the definitions for the locating points, and the dashed lines lead from the locating points to the inventive global identifiers.

The global identifier of a measurement point is determined as follows:

Let MP_{—}1 be a measurement point of the design of the partial object TO_{—}1. MP_{—}1 will be assumed to be associated with a measurement MES with two measurement points MP_{—}1 and MP_{—}2. Let MP_{—}2 be a measurement point of the design of the partial object TO_{—}2, TO_{—}2=TO_{—}1 is possible. The global identifier of MP_{—}1 is composed of the following information:

1. the identifier of TO_{—}1,

2. the element identifying that MP_{—}1 is a measurement point, and the type of the measurement MES,

3. if the design of TO_{—}1 comprises a plurality of measurement points: a local identifying element which distinguishes MP_{—}1 from other measurement points of the design of TO_{—}1, for example a serial number for all the measurement points of the design of TO_{—}1,

4. the identifier of TO_{—}2

5. if the design of TO_{—}2 comprises a plurality of measurement points: a local identifying element which distinguishes MP_{—}2 from other measurement points on TO_{—}2,

The 3rd and the 5th identifying elements are two local ones because they are only uniquely defined within TO_{—}1 or TO_{—}2.

If the measurement point MP_{—}1 is also associated with a further measurement, the global identifier of MP_{—}1 is correspondingly expanded by adding the identifiers of a further partial object TO_{—}3, and local identifying elements for measurement points of the design of TO_{—}3.

If only one measurement point MP_{—}1 is associated with MES, the global identifier for MP_{—}1 is composed only of the first three information items. A point measurement in the y direction is an example of a measurement with only one measurement point.

The functionalities of CAD tools which are currently commercially available permit product designers to integrate measurements into CAD models manually. Various areas which are involved in the design and manufacture of products, for example quality management, production planning, pressing facilities, body shell construction and servicing, specify which points are associated with this measurement. However, a further refinement of the invention provides for design elements for measurements to be generated automatically. For this purpose, information about measurement points, in particular the global identifiers of the measurement points and information about the assembly sequence is evaluated. This is described in more detail in what follows.

Let MP_{—}1 and MP_{—}2 be the two measurement points of a measurement MES. As described above, the global identifier of the measurement point MP_{—}1 of the design of the partial object TO_{—}1 comprises the identifier of a partial object TO_{—}2, and a local identifying element which distinguishes MP_{—}2 from other measurement points of the design of TO_{—}2. In addition, it is possible to determine automatically from the global identifier of MP_{—}1 the type of the measurement MES, in particular to determine whether MES is a point measurement in the x direction, in the y direction, in the z direction, a gap measurement, an angle measurement, an offset measurement or a distance measurement.

The global identifier of MP_{—}1 is evaluated. A design element for the measurement MES is generated automatically. MP_{—}2 is selected from the measurement points of the design of TO_{—}2. Next, the partial object at which the measurement MES is carried out is determined automatically, and the design element for MES is thus assigned to the design of said partial object. For this purpose, in the tree structure for the assembly sequence, the nodes for TO_{—}1 and TO_{—}2 are identified and the first node in the assembly sequence which comes after TO_{—}1 and after TO_{—}2, and therefore stands for the first partial object TO in the assembly sequence in which TO_{—}1 and TO_{—}2 occur together is looked for. The automatically generated design element for MES is assigned to the design of the partial object TO. The global identifier of MES is composed of the following information:

the identifier of TO;

the identifying element indicating the type of the measurement MES;

the identifier of TO_{—}1;

the local identifying element of MP_{—}1:

the identifier of TO_{—}2; and

the local identifying element of MP_{—}2.

An example: let TO_{—}1 and TO_{—}2 be two components with the serial numbers 1234567 and 7654321. Let 1 and 3 be the two local identifying elements for MP_{—}1 at TO_{—}1 and for MP_{—}2 at TO_{—}2, respectively. Let S be the identifying element for a gap measurement. Let 1425364 be the serial number of the assembly to whose design the measurement is assigned. The design element for the gap measurement between MP_{—}1 and MP_{—}2 is provided with the global identifier Z1425364_S_A1234567_{—}1_A7654321_{—}3.

When a design element for a measurement is generated, a plurality of tests for lack of contradiction (consistency) are carried out automatically, these being specifically:

The global identifier of MP_{—}1 comprises the identifier of TO_{—}2 and a local identifying element which distinguishes MP_{—}2 from other measurement points of the design of TO_{—}2. Does the global identifier of MP_{—}2 conversely comprise the identifier of TO_{—}1 and a local identifying element for MP_{—}1?

Is the same type of identifying element for the type of measurement conversely associated with the global identifier of MP_{—}2? An example: let there be a note in the global identifier of MP_{—}1 that MP_{—}1 is a measurement point of a gap measurement. Is there a note in the global identifier of MP_{—}2 that MP_{—}2 is also associated with a gap measurement?

The above procedure indicating how a design element is generated for measurement is necessary if MES is a measurement with two measurement points. If only one measurement point is associated with MES (for example in the case of a point measurement in the x direction), the global identifier of MP_{—}1 is composed only of the following information:

the identifier of TO_{—}1;

the local identifying element of MP_{—}1; and

the identifying element indicating the type of the measurement MES.

The design element for MES is generated from this information and assigned to the design of the partial object TO_{—}1.

Further information is assigned to the automatically generated design elements for measurements. The set point value of each measurement is automatically obtained from the CAD models with the measurement points of the measurement, for example as a distance between two measurement points or as a set point value of a measurement point. Employees define tolerances for measurements.

In the embodiment described above, the spatial position of the reference point REF was compared with the spatial position and extent of further partial objects. A further embodiment comprises storing not only the spatial position and extent of further partial objects but also predefined further reference elements on these further partial objects in the third data storage device. The first reference point REF is compared with the further reference elements. If, in this context, a reference element REF_{—}2 which is compatible with the reference point REF is found, the further partial object whose design includes the reference element REF_{—}2 is determined as a target object.

If the embodiment is applied to the example illustrated by FIG. 5, it is inferred from the information about REF and the assembly sequence that REF can be compatible only with a further reference element on the component 210 or 220. The search is therefore restricted to those reference points on the components 210 and 220 which restrict the movement of a held component in the y direction and which are indirect holding. In the most favorable case, a spatial position, orientation or extent has to be taken into account only a single time in order to find the direct target object and a compatible reference point.

In the embodiment described last, reference elements were predefined on the further partial objects. By means of this embodiment of the method according to the invention, compatible reference elements are found on target objects, or it is defined that such reference elements do not exist. Alternatively, it is possible to generate a reference element automatically as part of the design of a further partial object if a target object is determined for the first reference element.

This is explained using the example illustrated by means of FIG. 5. REF is a reference point on the component 230 for indirect holding. For example by comparing the geometric positions and extents it is determined that the component 210 is the target object for REF. A reference point REF_{—}1 of the design of the component 210 which is compatible with REF is generated automatically. The spatial position of REF and the direction which is restricted by REF are obtained from the design of the component 230. The spatial position of REF_{—}1 and the direction which is restricted by REF_{—}1 are derived from this. It is preferably also checked whether the spatial orientations of REF and REF_{—}1, i.e. the directions of the normal vectors to the surfaces of the components 230 and 210, correspond. By contrast, if REF is a reference point for direct holding, a reference point which is compatible with REF is generated and assigned to the design of the device 200.

A further embodiment of the invention provides assigning a global identifier for a reference element, which global identifier indicates which further reference element the first reference element is compatible with. This embodiment is explained on with the example of a component which is secured, inter alia, by means of a holding device:

The first partial object is the component with the with the serial number 1234567. The first reference element is a reference point REF_{—}1 of the design of the component 1234567. The further partial object is the clamping device with the serial number 1010101. The further reference element is a reference point REF_{—}2 of the design of the device 1010101.

According to the invention, it is determined that the device 1010101 is the direct target object for the component 1234567 and to the reference element REF. The first reference point REF is compatible with the further reference point REF_{—}2, which is also determined according to the invention.

Global Identifiers are Assigned for These Reference Elements as Follows:

The CAD model of the component 1234567 comprises the first reference point REF which has the global identifier A1234567_F_S_Y4 according to the embodiment as claimed in claim 5 or claim 8. This identifier indicates that the reference point is associated with the design of the component 1234567, but not which target objects this reference point has.

The CAD model, and thus the design of the clamping device 1010101, comprises the further reference point REF_{—}2, which firstly has the global identifier V1010101_F_S_Y4.

In the embodiment according to claim 6, the global identifier of the further reference point REF_{—}2 is expanded with the result that it is possible to infer from the new global identifier the device with whose design the holding point is associated (specifically V1010101), which component is held (specifically A1234567), and how the spatial movement of the component A1234567 is restricted by the holding point. The new global identifier is therefore V1010101_F_S_Y4_A1234567.

The information as to which partial object holds and secures the component 1234567 at a specific holding point can be recovered automatically from the inventive global identifiers of the first and further reference points without the coordinates of reference points having to be compared again with the geometries of partial objects. Let A1234567_F_S_Y4 be the identifier of a design element. From the identifier it is possible to infer that it is a reference point of the design of the component A1234567. Let V1010101_F_S_Y4_A1234567 be the identifier of a further design element. From this identifier it can be inferred automatically that the design element:

is a holding point of the design of the device 1010101;

holds the component 1234567;

corresponds to the reference point_{—}4 of the design of the component 1234567; and

restricts its spatial movement in the y direction.

This embodiment with the inventive global identifiers thus saves computing time and requires less computing power if the method for determining target objects is carried out repeatedly. Geometric information needs to be compared only when the method is carried out for the first time, and global identifiers are compared when it is carried on other times. Preferably when it is carried out again a process is carried out to verify whether the reference element, which is compatible with the first reference element according to the global identifier, is actually compatible or has become no longer compatible, for example due to modification of the spatial position, orientation or restricted direction in comparison with the first time the method was carried out.

In the embodiment described last, information about relationships between partial objects and design elements was made available to computers using identifiers. This form presents the information in a compact fashion, and the information can be read in and processed by systems for CAD, PDM and tolerance simulation without additional expenditure. A person skilled in the art is aware of further techniques for making available such relationships to a data processing system, for example techniques of object-oriented system analysis such as structured analysis, semantic networks, entity relationship models, eXtended Markup Language and Unified Modeling Language, and techniques of object-oriented programming such as branching between software objects in programming languages such as Java and C++.

According to the invention there is an automatic determination of which further partial objects secure a specific first partial object at its reference points. The associated reference points of the designs of the holding partial objects are found automatically. The invention also teaches how the information as to which measurements are influenced by the definitions for each reference point of the design of the first partial object, in particular the spatial position, the spatial orientation and tolerance, is determined for this reference point. Those measurements which are influenced by the reference point_{—}4 at the component 1234567 are determined automatically. The results of tolerance simulations are read in and evaluated from the fifth data storage device for this purpose. The events comprise listing the influencing factors and identifying the weighting of the influencing factors. Those measurements in which the design element A1234567_F_Y4 or the design element Z1010101_F_Y4_A1234567 occur as influencing factors are automatically filtered out. As a result, all the measurements which are influenced by the definitions for reference point_{—}4 are determined. The influenced measurements are expediently evaluated by weighting for the degree of the influence which reference point_{—}4 has on the measurements. Those measurements on which reference point_{—}4 has an influence which exceeds a predefined limiting value, for example 50%, can be filtered out.

There is then the determination of which partial objects have what influence on measurements in which the component 1234567 is involved.

From the identifiers for design elements there is a determination of which design elements are associated with the design of the component 1234567 and are at the same time measurement points. The measurement with which at least one measurement point of the design of 1234567 is associated is determined for each of these measurement points from the identifiers of all the measurements. In addition, which measurements of the design of 1234567 are carried out is determined from the identifiers of all the measurements. All the measurements whose identifier includes the identifier for 1234567 are determined.

The results of the tolerance simulations are evaluated in order to determine which design elements influence the measurements which are identified in this way. In addition, in each case one identifying element for the degree of influence, for example the weighting factor described above, is determined. The design elements are advantageously sorted in decreasing order in accordance with the magnitude of the influence on the measurement on 1234567. The identifiers of these design elements are in turn evaluated in order to determine automatically the partial objects with whose designs the design elements are associated. In this way it is determined which design elements on which partial objects have what influence on a measurement on 1234567, and thus on 1234567 itself.

Further information is generated for each measurement MES. The results of the tolerance simulation are evaluated in order to obtain the mean value, variation and further statistical information about the measurement. This statistical information includes characterizations of the processing reliability for MES; a person skilled in the art knows the Cp and Cpk value. The information as to which partial objects the measurement points of MES are associated with is obtained from the identifier of MES. The information as to where these partial objects occur in the assembly sequence, and thus the information as to when this measurement is carried out, is obtained from the tree structure for the assembly sequence. Graphic representations of the partial objects and design elements are acquired from CAD models of these partial objects.

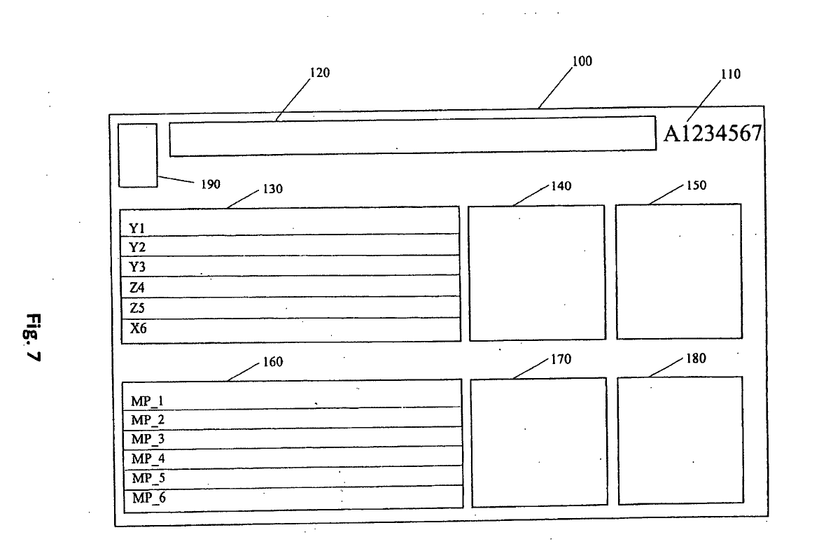

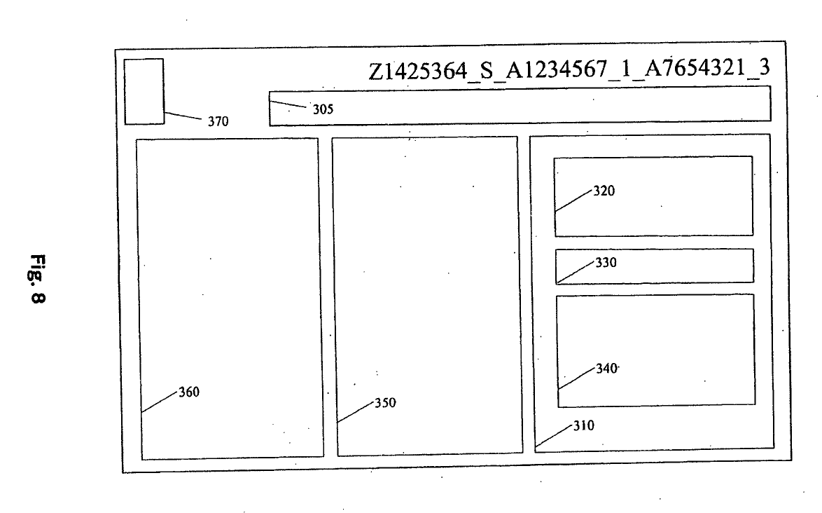

A further embodiment of the invention provides for a compact representation of the generated information about a partial object and a compact representation for a design element to be generated and made available automatically. This is explained with reference to FIG. 7 for a component, and with reference to FIG. 8 for a measurement. Reusable templates are preferably generated in advance for the documentation items. This template is preferably filled with the information which is generated according to the invention, and when necessary with further information about the first component including the first reference element. All the partial objects and design elements are preferably designated in these documentation items by means of the global identifiers according to the invention.

FIG. 7 shows the representation 100 of the information for the component with the serial number 1234567. The identifier 110 of the component is represented top right, and the management information 120 for the component is represented top left. This management information includes a designation of the component, denominations of function group, of those responsible and a date.

Information about the locating points of 1234567, which are used, for example for generating a clamping and securing concept, is represented in the blocks 130, 140 and 150. The three blocks are each divided into six lines, one per locating point. In block 130 there is a representation of which direction of the spatial movement of 1234567 is restricted by the locating point, and in addition there is a representation of the x, y and z coordinates of the locating point, those of the normal vector to the surface of 1234567 at the locating point, as well as the tolerance of the locating point with respect to 1234567. In block 140 there is a representation of the target object which has been determined for the locating point, and of the tolerance which the target object has with respect to the locating point. In block 150 there is a representation of the measurements which are influenced by the definitions for the locating point, and of an element identifying the weighting of this influence. Only those measurements on which the locating point has a critical influence, for example a threshold value which is predefined with a weighting greater than one are specified in block 150.

Information about the measurements with which a measuring point at 1234567 is associated are represented in blocks 160, 170 and 180. An identifier of the measurement point at 1234567, an identifier of the measurement and, if the measurement has two measurement points, an identifier of the second measurement point, are represented in block 160. Statistical information about the measurement, in particular mean value, variation, Cp and Cpk value, are represented in block 170. The greatest influencing factor on the measurement is represented in block 180 and is described by means of an identifier of the design element, and an element identifying the magnitude of the influence.

The block 190 is in the form of a light signal system (traffic light function) which displays an evaluation for the current state of the design of the component in the global system. Results of the tolerance simulation are included in the evaluation. A traffic light which is switched to red indicates that this component is frequently a main factor causing undesired simulation results and therefore has a critical influence on the design of the entire physical object.

FIG. 8 shows the representation 300 of the information for a measurement with the identifier Z1425364_S_A1234567_{—}1_A7654321_{—}3.

Management information for the measurement is displayed in block 305. This includes the measurement points which are associated with the measurement, the identifiers of the partial objects with whose designs these measurement points are associated (here: A1234567 and A7654321), as well as the partial object whose design the measurement is associated with (here: Z1425364). Moreover, a textual description of the measurement is displayed.

Those results of a tolerance simulation which relate to the measurement Z1425364_S_A1234567_A_A7654321_{—}3 are represented in block 310. A histogram 320 for the variation of the measurement over a value range and a partial block 330 with statistical information about the measurement, for example mean value, median, standard deviation, cp and cpk value and confidence interval for the proportion of measurements which lie within a predefined tolerance are shown.

The influencing factors on the measurement Z1425364_S_A1234567_{—}1_A7654321_{—}3 are shown in the partial block 340, specifically preferably in decreasing order according to the degree of influence on the measurement. Each influencing factor is a design element which is designated by its inventive global identifier. This global identifier comprises the type of design element, the associated partial object and, if present, a reference to compatible design elements. In addition, the magnitude of the influence (for example in the form of the maximum possible influence on the variation) and, if predefined, the tolerance are specified. The values of these influences are illustrated by means of bars.

A detail from the assembly sequence is illustrated in block 350. This detail comprises the identifiers of the partial objects with whose designs the measurement points of the measurement are associated (here: A1234567 and A7654321). A graphic representation of the designs of the partial objects with which the measurement points of the measurement are associated (here: A1234567 and A7654321) is shown in block 360.

Block 370 is in the form of a light signal display (traffic light function) which illustrates to what degree those results of the tolerance simulation which affect the measurement correspond to the predefined values for the measurement.

According to a further embodiment, the differences and effects which are determined automatically are evaluated with the aim of generating and sending messages which can be used to inform designers of other components if the variation of a design element which is associated with the design of a component 1234567 exceeds a predefined value for the tolerance. A decision rule which is defined in advance is evaluated for this. An embodiment of the decision rule is that the designer of a component 7654321 is informed if a design element of the design of 7654321 whose variation, standard deviation or some other measure of the variation of the simulation results for MES is greater than the predefined tolerance is associated with MES. The designer of 1234567 is informed, by means of an automatically generated and sent message, that the variation of MES exceeds the predefined tolerance, and that the designer of 7654321 has been informed of this.

These messages are probably sent as e-mails. A data processing system has read access to the differences and effects which are determined according to the invention, and to an electronic table which contains, for each component, the e-mail address of the designer who is responsible for this component.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

List of Reference Numbers

| Number | Meaning |
|---|---|
| 10 | Primary plane (1st locating plane) |
| 11, 12, 13 | Three reference points of the primary plane |
| 20 | Secondary plane (2^{nd} locating plane) |
| 21, 22 | Two reference points of the secondary plane |
| 30 | Tertiary plane |
| 31 | A reference point of the tertiary plane |
| 40 | Profile of a surface with tolerances |
| 41 | Position with tolerances |
| 50 | A device |
| 51, 52 | Two components |
| 53 | An assembly |
| 100 | Representation of information about the component |
| | A1234567 |
| 110 | Representation of the identifier of a component |
| 120 | Management information for a component |
| 130 | Representation of the spatial movement which is restricted |
| | by locating point |
| 140 | Target objects for the reference points |
| 150 | Measurements which are influenced by the locating points |
| 160 | Identifiers of a measurement point on the component and |
| | management information |
| 170 | Statistical information about a measurement |
| 180 | Influencing factors on the measurement |
| 190 | Traffic light function for evaluating the component |
| 200 | A device |
| 210, 220 | Two holding components |
| 230 | One held component |
| 240 | Assembly of 210, 220, 230 |
| 300 | Representation of information for the measurement |
| | Z1425364_S_A1234567_1_A7654321_3 |
| 305 | Management information for the measurement |
| 310 | Representation of results of a tolerance simulation for the |
| | measurement |
| 320 | Histogram for the variation of a measurement |
| 330 | Block with statistical information on the measurement |
| 340 | Influencing factors on the measurement |
| 350 | Detail from an assembly sequence |
| 360 | Graphic representation of the designs of the partial objects |
| | with which the measurement points of the measurement are |
| | associated |
| 370 | Traffic light function for evaluating the measurement |

1-13. (Cancelled)

14. In designing a physical object, a method for selecting further partial objects whose designs are affected by definitions for a first reference element on the first partial object, wherein,
the selection is carried out automatically by a data processing system;
the design of each of the partial objects comprises spatial extent and spatial position for the partial object;
the design of the first partial object comprises the first reference element;
for the first reference element, spatial position and a direction in which the reference element restricts the spatial movement of the first partial object are defined; and
an assembly sequence which includes the first partial object is defined;
said method comprising:
a) for each further partial object that occurs after the first partial object in an assembly sequence, executing steps b) and c);
b) testing to determine whether the further partial object holds or secures the first partial object in the first reference element, in which case, during the test, the spatial position of the first reference element is compared with the spatial extent and position of the further partial object, and the direction which is restricted by the first reference element is compared with the spatial orientation of the further partial object; and
c) selecting the further partial object, if no comparison provides a difference which is greater than a predefined limit.

15. In a process for designing a physical object, including designing a first partial object and at least one further partial object of said physical object, a method for selecting further partial objects whose designs are affected by definitions for a first reference element on the first partial object, wherein,
the selection is carried out automatically by a data processing system;
the design of each of the partial objects comprises spatial extent and spatial position for the partial object;
the design of each partial object comprises at least one design element or is expandable by adding at least one design element;
the design of the first partial object comprises the first reference element; and
for each reference element, geometric information is defined which comprises spatial position of the reference element; and
an assembly sequence which includes the first partial object is defined;
said method comprising:
a) for each further partial object that occurs after the first partial object in an assembly sequence, executing of steps b) and c);
b) testing to determine whether the further partial object holds and/or secures the first partial object in the first reference element, in which case, during the testing,
it is tested whether the design of the further partial object comprises a reference element that is compatible with the first reference element; and
geometric information of the first reference element is compared with geometric information of at least one further reference element on the further partial object and a decision is made as to whether there is compatibility between the first reference element and the further reference element; and
c) selecting the further partial object if a compatible reference element is found on the further partial object.

16. The method as claimed in claim 15, wherein the geometric properties, used for a test, for each reference element comprise at least one of the following information items:
whether the design element is a locating point of a partial object, a holding point of a partial object, a locating surface of a partial object, or a holding surface of a partial object;
the direction in which the reference element restricts the spatial movement of that partial object with whose design the reference element is associated; and
a design tolerance, position tolerance or dimensional tolerance for the reference element.

17. The method as claimed in claim 15, wherein:
if both the first and the further reference elements are reference points, a normal vector to the surface of the first partial object in the first reference point and a normal vector to the surface of the further partial object in the further reference point are determined;
if both the first reference element and the further reference element are reference surfaces, a normal vector to the first reference surface and a normal vector to the further reference surface are determined; and
if the two normal vectors do not correspond, it is determined that there is no compatibility between the first reference element and the further reference element.

18. The method as claimed in claim 15, wherein:
if there is compatibility between the first reference element and the further reference element, the first reference element is characterized by a global identifier which comprises an identifier that characterizes the further partial object, an identifier which distinguishes the further reference element from other reference elements of the further partial object, and an identifier for the type of the further reference element.

19. The method as claimed in claim 15, wherein, if there is compatibility between the first reference element and the further reference element, the further reference element is characterized by a global identifier, which comprises an identifier that characterizes the first partial object, an identifier which distinguishes the first reference element from other reference elements of the first partial object, and an identifier for the type of the first reference element.

20. The method as claimed in claim 19, wherein:
the method is carried out iteratively;
when the method is carried out, the global identifier of the further reference element is generated;
when the method is carried out currently or at a subsequent time, the compatibility of a further reference element with the first reference element is tested only if the global identifier of the further reference element comprises an identifier of the first partial object, an identifier which distinguishes the first reference element from other reference elements of the design of the first partial object, and an identifier for the type of the first reference element.

21. The method as claimed in claim 14, wherein:
the first reference element is characterized by a global identifier which comprises an identifier of the first partial object, an identifier which distinguishes the first reference element from other reference elements of the design of the first partial object, and an identifier for the type of the first reference element; and
if a further partial object has been selected and no other selected partial object occurs in the assembly sequence between the first partial object and the further partial object; the global identifier of the first reference element is expanded by adding an identifier which characterizes the selected further partial object.

22. The method as claimed in claim 18, wherein:
the method is carried out iteratively;
when the method is carried out the global identifier of the first reference element is generated; and
when the method is carried out currently or a subsequent time, the testing as to whether the further partial object holds or secures the first partial object in the first reference element is carried out only for those further partial objects whose identifiers are included in the global identifier of the first reference element.

23. The method as claimed in claim 21, wherein:
the method is carried out iteratively;
when the method is carried out the global identifier of the first reference element is generated; and
when the method is carried out currently or a subsequent time, the testing as to whether the further partial object holds or secures the first partial object in the first reference element is carried out only for those further partial objects whose identifiers are included in the global identifier of the first reference element.

24. The method as claimed in claim 14, wherein, if a further partial object has been selected, either a further reference element is generated which is associated with the design of the selected partial object and is compatible with the first reference element, the further reference element comprising an identifier and the spatial position in relation to the selected partial object, or it is determined that a compatible further reference element cannot be generated.

25. The method as claimed in claim 24, wherein:
both the first reference element and the further reference element are one of reference points and reference surfaces; and
the first reference element and the further reference element correspond in terms of their spatial positions, of the normal vector to the surface of the respective partial object or the respective reference surface, of the direction in which the spatial movement of the respective partial object is restricted, or of the type of the reference element.

26. A computer program product which can be loaded directly into an internal memory of a computer and comprises software sections with which a method as claimed in claim 14 can be carried out if the product runs on a computer.

27. A computer program product which can be loaded directly into an internal memory of a computer and comprises software sections with which a method as claimed in claim 15 can be carried out if the product runs on a computer.

28. A computer program product which is stored on a computer-readable medium and which has computer-readable program means which cause the computer to carry out a method as claimed in claim 14.

29. A computer program product which is stored on a computer-readable medium and which has computer-readable program means which cause the computer to carry out a method as claimed in claim 15.
